(19) United States
(12) Patent Application Publication
(10) Pub. No.: US 2026/0305509 A1
(43) Pub. Date: Oct. 8, 2026

(54) CUSTOMIZABLE GARDEN TOOL

(71) Applicant: Corey Spencer, Payson, UT (US)

(72) Inventor: Corey Spencer, Payson, UT (US)

(21) Appl. No.: 19/171,822

(22) Filed: Apr. 7, 2025

(51) Int. Cl. A01B 1/02; A01B 1/20; A01D 7/00; B25G 3/36

(52) U.S. Cl. CPC A01B 1/022; A01B 1/20; A01D 7/00; B25G 3/36

(57) ABSTRACT

A customizable garden tool, including a handle, a removable shovel configured to be removably attachable to a first end of the handle, and a removable rake configured to be removably attachable to a second end of the handle.

### BACKGROUND

### 1. Field

The present general inventive concept relates generally to a garden tool, and particularly, to a customizable garden tool.

### 2. Description of the Related Art

Working in one's yard, garden, or farm is an activity that often requires multiple tools, such as rakes, shovels, hoes, pitchforks, tillers, etc.

However, workers often need multiple tools for a single session of outdoor work.

Therefore, there is a need for a tool that combines multiple different types of tools for quick and easy access.

### SUMMARY

The present general inventive concept provides a customizable garden tool.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a customizable garden tool, including a handle, a removable shovel configured to be removably attachable to a first end of the handle, and a removable rake configured to be removably attachable to a second end of the handle.

The handle may include a gripping portion disposed at a middle portion of the handle and configured to allow a user to grip the handle, a first threaded end disposed at a first end of the gripping portion, and a second threaded end disposed at a second end of the gripping portion.

The removable shovel may include a shovel portion having a shape of a shovel configured to scoop dirt, a shovel attachment end disposed at an end of the removable shovel opposite from the shovel portion, and a shovel threaded aperture disposed within the shovel attachment end and configured to screw onto the first threaded end of the handle.

The removable rake may include a rake portion having a shape of a rake configured to rake leaves, a rake attachment end disposed at an end of the removable rake opposite from the rake portion, and a rake threaded aperture disposed within the rake attachment end and configured to screw onto the second threaded end of the handle.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates an angled perspective view of a customizable garden tool, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### List of Components

Customizable Garden Tool 100
Handle 110
Gripping Portion 111
First Threaded End 112
Second Threaded End 113
Removable Shovel 120
Shovel Portion 121
Shovel Attachment End 122
Shovel Threaded Aperture 123
Removable Rake 130
Rake Portion 131
Rake Attachment End 132
Rake Threaded Aperture 133

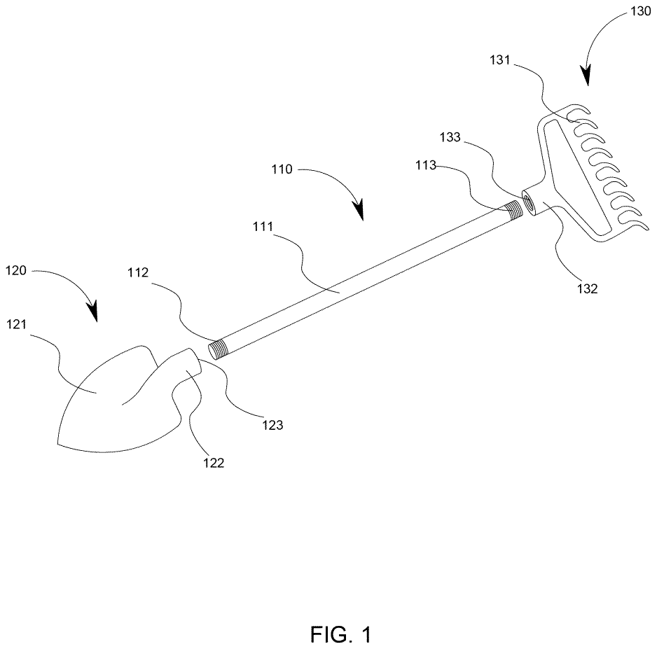

FIG. 1 illustrates an angled perspective view of a customizable garden tool 100, according to an exemplary embodiment of the present general inventive concept.

The customizable garden tool 100, and all components therein, may be constructed from at least one of wood, plastic, metal, silicone, liquid, fibers, threads, fabric, foam, sponge, nylon, vinyl, feathers, glass, adhesives, salts, and rubber, etc., but is not limited thereto, and can be constructed from any material known to one of ordinary skill in the art.

Referring to FIG. 1, the customizable garden tool 100 may include a handle 110, a removable shovel 120, and a removable rake 130, but is not limited thereto.

The handle 110 may have a shape of a pole, but may have any type of shape known to one of ordinary skill in the art.

The removable shovel 120 may have a shape of any type of conventional shovel known to one of ordinary skill in the art, and the removable rake 130 may have a shape of any type of conventional rake known to one of ordinary skill in the art.

Even though FIG. 1 depicts the removable shovel 120 as a shovel and the removable rake 130 as a rake, any type of garden tool may replace the removable shovel 120 or the removable rake 130, such as a hoe, a pitchfork, a tiller, a sickle, etc.

The handle 110 may include a gripping portion 111, a first threaded end 112, and a second threaded end 113, but is not limited thereto.

The gripping portion 111 may be an entire middle section of the handle 110 disposed between the first threaded end 112, which may be disposed at a first end of the handle 110, and the second threaded end 113, which may be disposed at a second end of the handle 110, and may be configured to be grippable by a user.

The removable shovel 120 may include a shovel portion 121, a shovel attachment end 122, and a shovel threaded aperture 123, but is not limited thereto.

The removable rake 120 may be attachable to and/or detachable from the handle 110.

The shovel portion 121 may be a portion of the removable shovel 120 that allows a user to scoop dirt, for example, similarly to a conventional shovel.

The shovel attachment end 122 may be disposed at an end of the removable shovel 120 opposite from the shovel portion 121, and may include a shovel threaded aperture 123 disposed within the shovel attachment end 122 to correspond to and to attach to the first threaded end 112 of the handle 110. As such, the removable shovel 120 may be screwed onto the first threaded end 112 of the handle 110 via the shovel threaded aperture 123 of the shovel attachment end 122.

The removable rake 130 may include a rake portion 131, a rake attachment end 132, a rake threaded aperture 133, but is not limited thereto.

The removable rake 130 may be attachable to and/or detachable from the handle 110.

The rake portion 131 may be a portion of the removable rake 130 that allows a user to rake leaves, for example, similarly to a conventional rake.

The rake attachment end 132 may be disposed at an end of the removable rake 130 opposite from the rake portion 131, and may include a rake threaded aperture 133 disposed within the rake attachment end 132 to correspond to and to attach to the second threaded end 113 of the handle 110. As such, the removable rake 130 may be screwed onto the second threaded end 113 of the handle 110 via the rake threaded aperture 133 of the rake attachment end 132.

The present general inventive concept may include a customizable garden tool 100, including a handle 110, a removable shovel 120 configured to be removably attachable to a first end of the handle 110, and a removable rake 130 configured to be removably attachable to a second end of the handle 100.

The handle 110 may include a gripping portion 111 disposed at a middle portion of the handle 110 and configured to allow a user to grip the handle 110, a first threaded end 112 disposed at a first end of the gripping portion 111, and a second threaded end 113 disposed at a second end of the gripping portion 111.

The removable shovel 120 may include a shovel portion 121 having a shape of a shovel configured to scoop dirt, a shovel attachment end 122 disposed at an end of the removable shovel 120 opposite from the shovel portion 121, and a shovel threaded aperture 123 disposed within the shovel attachment end 122 and configured to screw onto the first threaded end 112 of the handle 110.

The removable rake 130 may include a rake portion 131 having a shape of a rake configured to rake leaves, a rake attachment end 132 disposed at an end of the removable rake 130 opposite from the rake portion 131, and a rake threaded aperture 133 disposed within the rake attachment end 132 and configured to screw onto the second threaded end 113 of the handle 100.

A main purpose of the present general inventive concept is to provide a versatile and efficient tool system designed for various household, gardening, and outdoor tasks. This innovative approach allows users to tackle a wide range of activities without the need for multiple single-purpose tools, streamlining both storage and functionality. By offering interchangeable attachments that can be easily swapped out, the present general inventive concept enables users to adapt quickly to different tasks, whether they are gardening, landscaping, or performing general maintenance. Consisting of three main components, each contributing to its overall effectiveness, the accessory possesses interchangeable attachments: various tool heads such as shovels, rakes, hoes, and more. These attachments are specifically designed for distinct functions, making it easy for users to switch from one tool to another without hassle. Second, the durable double-end stick or handle serves as the core component of the system. This robust and ergonomically designed handle provides a solid foundation for all attachments, ensuring that it can withstand the rigors of various tasks while remaining comfortable to use. The third key feature of the present general inventive concept is its threaded ends—both male and female—which allow for quick and secure attachment changes. This design not only facilitates easy swapping of tools but also enables users to connect multiple handles for extended reach, when needed. This adaptability makes the tool particularly useful for a wide range of applications, from agriculture and construction to household maintenance and seasonal tasks. The present general inventive concept effectively addresses several common problems faced by users of traditional tools. One significant issue is storage efficiency; by eliminating the need for multiple tool handles it reduces clutter in storage spaces. Additionally, its versatility allows users to quickly switch between different tools without having to change the entire implementation, saving time and effort during tasks. The system is also cost-effective, as it replaces multiple single-purpose tools with one adaptable solution, potentially saving money in the long run. Portability is another advantage of the present general inventive concept; transporting a single handle with various attachments is far easier than carrying several full-sized tools. This feature is especially beneficial for those with limited storage space or who frequently work in different locations. Furthermore, the present general inventive concept's design is suitable for a variety of tasks across different seasons and applications, whether it's gardening in spring or snow shoveling in winter, making it a practical choice for both casual users and professionals. In summary, the present general inventive concept combines versatility, efficiency, and smart storage in one innovative system that has the potential to become a go-to accessory within the hardware/tools industry.

The present general inventive concept is unique in its innovative design that combines versatility and efficiency in a single tool system. By featuring a durable handle with threaded ends that can accommodate various interchangeable attachments, the present general inventive concept allows users to quickly switch between different tools like shovels, rakes, and hoes without needing multiple full-sized implements. This design not only saves storage space and reduces clutter but also enhances portability and adaptability across a wide range of tasks, from gardening and landscaping to household maintenance and seasonal work. The present general inventive concept maintains the familiar feel and effectiveness of traditional tools while offering the flexibility to tackle diverse jobs with a single, adaptable solution, making it a practical and cost-effective choice for both casual users and professionals in various industries.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A customizable garden tool, comprising:
a handle;
a removable shovel configured to be removably attachable to a first end of the handle; and
a removable rake configured to be removably attachable to a second end of the handle.

2. The customizable garden tool of claim 1, wherein the handle comprises:
a gripping portion disposed at a middle portion of the handle and configured to allow a user to grip the handle;
a first threaded end disposed at a first end of the gripping portion; and
a second threaded end disposed at a second end of the gripping portion.

3. The customizable garden tool of claim 2, wherein the removable shovel comprises:
a shovel portion having a shape of a shovel configured to scoop dirt;
a shovel attachment end disposed at an end of the removable shovel opposite from the shovel portion; and
a shovel threaded aperture disposed within the shovel attachment end and configured to screw onto the first threaded end of the handle.

4. The customizable garden tool of claim 3, wherein the removable rake comprises:
a rake portion having a shape of a rake configured to rake leaves;
a rake attachment end disposed at an end of the removable rake opposite from the rake portion; and
a rake threaded aperture disposed within the rake attachment end and configured to screw onto the second threaded end of the handle.
